(19) United States
(12) Patent Application Publication
(10) Pub. No.: US 2016/0255560 A1
(43) Pub. Date: Sep. 1, 2016

(54) Providing Wireless Terminal Uplink Data Rate Offsets

(71) Applicant: TELEFONAKTIEBOLAGET L M ERICSSON (PUBL), Stockholm (SE)

(72) Inventors: Ari Kangas, Lidingö (SE); Billy Hogan, Sollentuna (SE); Cagatay Konuskan, Stockholm (SE)

(21) Appl. No.: 14/380,485

(22) PCT Filed: Apr. 24, 2014
(86) PCT No.: PCT/SE2014/050500

§ 371 Date: Aug. 22, 2014

Related U.S. Application Data
(60) Provisional application No. 61/817,516, filed on Apr. 30, 2013.

(51) Int. Cl. H04W 36/18; H04W 52/38; H04B 17/336; H04W 72/04; H04L 1/18

(52) U.S. Cl. CPC H04W 36/18; H04W 72/0413; H04L 1/1812; H04B 17/336; H04W 52/386; H04W 88/12

(57) ABSTRACT

Methods to provide communications with a wireless terminal in a soft handover are provided. A method to provide communications with a wireless terminal in a soft handover may include receiving, when the wireless terminal is in the soft handover with respect to a serving base station and a non-serving base station, a retransmission indication through the non-serving base station or the serving base station. The method may include generating an uplink data rate offset value responsive to the retransmission indication. Moreover, the method may include transmitting the uplink data rate offset value to the serving base station for transmission to the wireless terminal. Related nodes and wireless terminals are also provided.

### TECHNICAL FIELD

The present disclosure is directed to communications and, more particularly, to wireless communications.

### BACKGROUND

In a typical cellular radio system, wireless terminals (also referred to as user equipment unit nodes, UEs, and/or mobile stations) communicate via a radio access network (RAN) with one or more core networks. The RAN covers a geographical area that is divided into cell areas, with each cell area being served by a radio base station (also referred to as a RAN node, a “NodeB,” and/or enhanced NodeB “eNodeB”). A cell area is a geographical area where radio coverage is provided by the base station equipment at a base station site. The base stations communicate through radio communication channels with UEs within range of the base stations.

Moreover, a cell area for a base station may be divided into a plurality of sectors (also referred to as cells) surrounding the base station. For example, a base station may service three 120-degree sectors/cells surrounding the base station, and the base station may provide a respective directional transceiver and sector antenna array for each sector. Stated in other words, a base station may include three directional sector antenna arrays servicing respective 120-degree base station sectors surrounding the base station.

Although base stations may attempt to control the power of wireless terminals, power fluctuations may still occur, which may lead to system instability.

The approaches described in this Background section could be pursued, but are not necessarily approaches that have been previously conceived or pursued. Therefore, unless otherwise expressly stated herein, the approaches described in this Background section are not prior art to the claims in this application and are not admitted to be prior art by inclusion in this section.

### SUMMARY

Various embodiments provide a method to provide communications with a wireless terminal in a soft handover. The method includes receiving, when the wireless terminal is in the soft handover with respect to a serving base station and a non-serving base station, a retransmission indication through the non-serving base station or the serving base station. The method includes generating an uplink data rate offset value responsive to the retransmission indication. Moreover, the method includes transmitting the uplink data rate offset value to the serving base station for transmission to the wireless terminal

A node of a radio access network configured to provide communications with a wireless terminal in a soft handover, according to various embodiments is provided. The node includes a network interface configured to provide communications with a serving base station and a non-serving base station. The node includes a processor coupled to the network interface. The processor is configured to receive, when the wireless terminal is in a soft handover with respect to the serving base station and the non-serving base station, a retransmission indication through the network interface from the non-serving base station or the serving base station. The processor is configured to generate an uplink data rate offset value responsive to the retransmission indication. Moreover, the processor is configured to transmit the uplink data rate offset value to the serving base station for transmission to the wireless terminal.

A method in a node, according to various embodiments, is provided. The method includes receiving from a Radio Network Controller an uplink data rate offset value used to adjust an uplink data rate of a wireless terminal, when the wireless terminal is in a soft handover. Moreover, the method includes transmitting the uplink data rate offset value to the wireless terminal when the wireless terminal is in the soft handover.

A node of a radio access network configured to provide communications with a wireless terminal, according to various embodiments, is provided. The node includes transceiver circuitry configured to provide communications with the wireless terminal. The node includes a network interface configured to provide communications with a Radio Network Controller. Moreover, the node includes a processor coupled to the transceiver circuitry and the network interface. The processor is configured to receive, through the network interface, from the Radio Network Controller an uplink data rate offset value used to adjust an uplink data rate of the wireless terminal, when the wireless terminal is in a soft handover. Moreover, the processor is configured to transmit the uplink data rate offset value through the transceiver circuitry to the wireless terminal when the wireless terminal is in the soft handover.

A method in a wireless terminal, according to various embodiments, is provided. The method includes transmitting an uplink data block to a non-serving base station and/or a serving base station when the wireless terminal is in a soft handover with respect to the serving base station and the non-serving base station. The method then includes receiving, through the serving base station, an uplink data rate offset value generated by a Radio Network Controller used to adjust an uplink data rate of the wireless terminal, when the wireless terminal is in the soft handover.

A wireless terminal, according to various embodiments, is provided. The wireless terminal includes a transceiver configured to provide communications with a non-serving base station and a serving base station. Moreover, the wireless terminal includes a processor coupled to the transceiver. The processor is configured to transmit, through the transceiver, an uplink data block to the non-serving base station and/or the serving base station when the wireless terminal is in a soft handover with respect to the serving base station and the non-serving base station. Moreover, the processor is configured to then receive, through the transceiver, from the serving base station, an uplink data rate offset value generated by a Radio Network Controller used to adjust an uplink data rate of the wireless terminal, when the wireless terminal is in the soft handover.

Accordingly, various embodiments described herein may improve soft handover performance by adjusting legacy behavior. For example, by performing a rate offset calculation in a Radio Network Controller in a case of a soft handover, performance may improve. When a UE is in a soft handover, performing a rate offset calculation in the Radio Network Controller may be advantageous because only the Radio Network Controller has full knowledge about Hybrid Automatic Repeat Request (HARQ) retransmission performance from all cells in an active set.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of inventive concepts. In the drawings:

FIG. 1 is a block diagram of a communication system that is configured according to some embodiments;

FIGS. 2A, 2B, 2C, and 2D are block diagrams respectively illustrating a base station, a base station controller, a radio network controller, and a wireless terminal according to some embodiments of FIG. 1;

FIGS. 3A and 3B are schematic diagrams respectively illustrating intra node and inter node communications according to some embodiments;

FIG. 4 is a flow chart illustrating operations of radio access network nodes according to some embodiments;

FIG. 5 is a schematic diagram illustrating power control operations of radio access network nodes according to some embodiments;

FIG. 6 is a graph of signal levels and received power at a base station according to some embodiments; and

FIG. 7 is a schematic diagram illustrating uplink data rate adaptation operations of radio access network nodes according to some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

For purposes of illustration and explanation only, these and other embodiments of present inventive concepts are described herein in the context of operating in a RAN that communicates over radio communication channels with wireless terminals (also referred to as UEs). It will be understood, however, that present inventive concepts are not limited to such embodiments and may be embodied generally in any type of communication network. As used herein, a wireless terminal (also referred to as a UE) can include any device that transmits/receives data to/from a wireless communication network, and may include, but is not limited to, a mobile telephone (“cellular” telephone), laptop/portable computer, pocket computer, hand-held computer, and/or desktop computer.

In some embodiments of a RAN, several base stations can be connected (e.g., by landlines or radio channels) to a radio network controller (RNC). The radio network controller, also sometimes termed a base station controller (BSC), supervises and coordinates various activities of the plural base stations connected thereto. The radio network controller is typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) technology. UTRAN, short for UMTS Terrestrial Radio Access Network, is a collective term for the NodeBs and Radio Network Controllers that make up the UMTS radio access network. Thus, UTRAN is essentially a radio access network using wideband code division multiple access for UEs.

The Third Generation Partnership Project (3GPP) has undertaken to further evolve the UTRAN and GSM based radio access network technologies. In this regard, specifications for the Evolved Universal Terrestrial Radio Access Network (E-UTRAN) are ongoing within 3GPP. The Evolved Universal Terrestrial Radio Access Network (E-UTRAN) comprises the Long Term Evolution (LTE) and System Architecture Evolution (SAE).

Note that although terminology from HSUPA (High Speed Uplink Packet Access) and/or WCDMA (Wideband Code Division Multiple Access) is used in this disclosure to describe example embodiments of inventive concepts, this should not be seen as limiting the scope of inventive concepts to only these systems. Other wireless systems, including WiMax (Worldwide Interoperability for Microwave Access), UMB (Ultra Mobile Broadband), 3GPP (3^{rd} Generation Partnership Project) LTE (Long Tenn Evolution), GSM (Global System for Mobile Communications), etc., may also benefit from exploiting embodiments of present inventive concepts disclosed herein.

Also note that terminology such as base station (e.g., a NodeB and/or eNodeB) and wireless terminal (also referred to as UE or User Equipment node) should be considered non-limiting and does not imply a certain hierarchical relation between the two. In general, a base station (e.g., a NodeB and/or eNodeB) and a wireless terminal (e.g., a “UE”) may be considered as examples of respective different communications devices that communicate with each other over a wireless radio channel. While embodiments discussed herein may focus on wireless transmissions in an uplink from a UE to an NodeB/eNodeB, embodiments of inventive concepts may also be applied, for example, in the downlink.

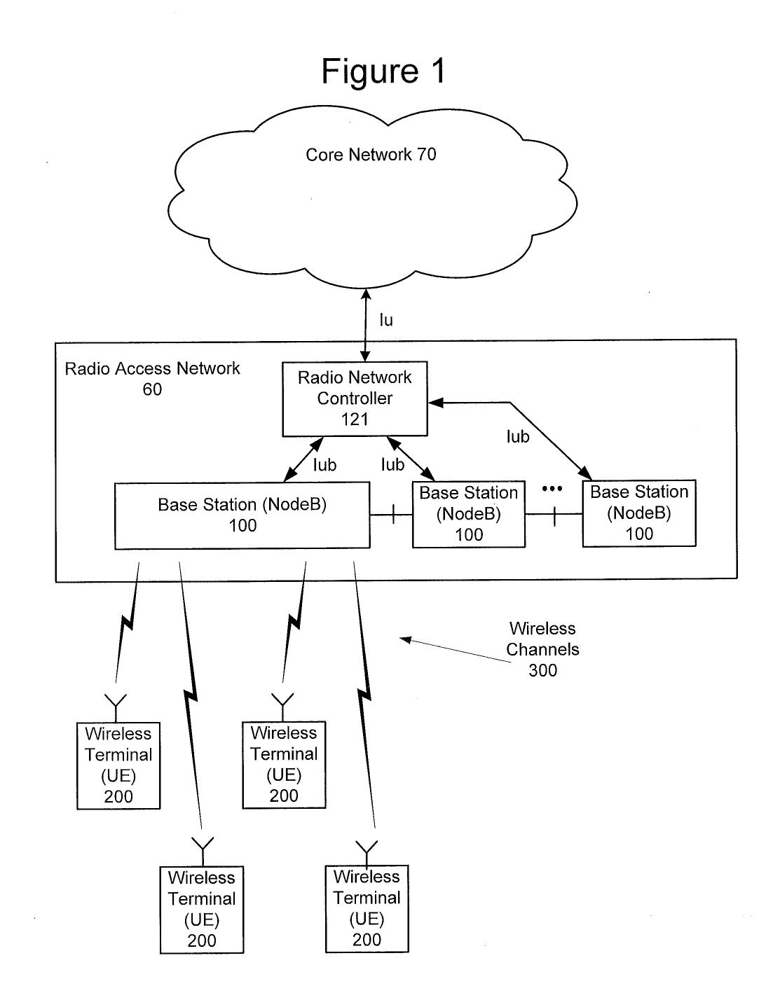

FIG. 1 is a block diagram of a communication system that is configured to operate according to some embodiments of present inventive concepts. An example RAN 60 is shown that may be a High Speed Packet Access (HSPA). Alternatively, a Long Term Evolution (LTE) RAN may be used. Radio base stations 100 may be coupled to core networks 70 through one or more radio network controllers (RNC) 121, and/or radio base stations (e.g., NodeBs and/or eNodeBs) 100 may be connected directly to one or more core networks 70. In some embodiments, functions of a radio network controller (RNC) 121 may be performed by radio base stations 100. Radio base stations 100 communicate over wireless channels 300 (also referred to as a Uu interface) with wireless terminals (also referred to as user equipment nodes or UEs) 200 that are within their respective communication service cells (also referred to as coverage areas). Moreover, the radio base stations 100 can communicate with the RNC 121 through interfaces Iub, and the RNC 121 can communicate with the core network 70 through an interface Iu.

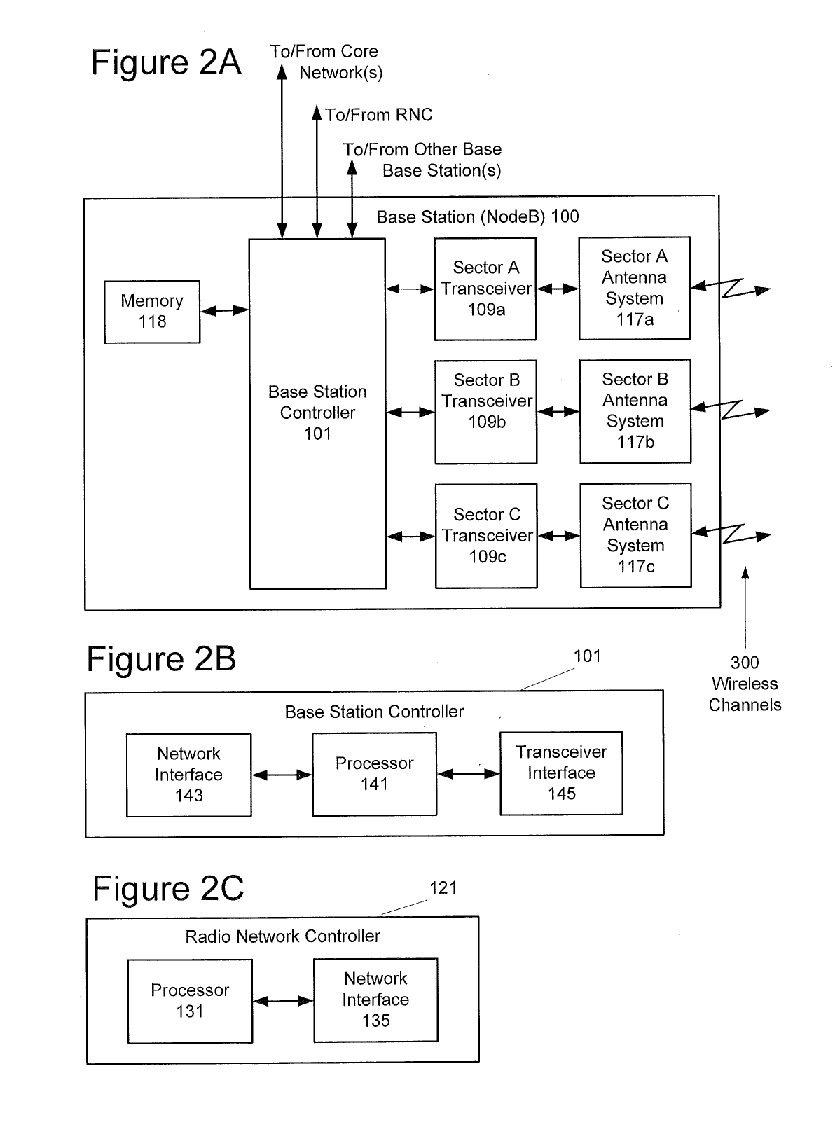

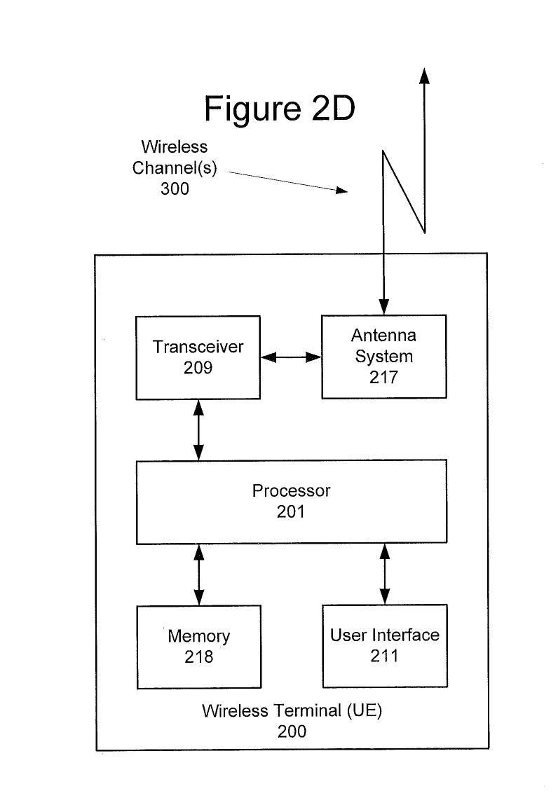

FIG. 2A is a block diagram of a base station 100 of FIG. 1 configured to provide service over three 120-degree sectors (sectors A, B, and C) surrounding the base station according to some embodiments. As shown, for example, base station 100 may include three transceivers 109a, 109b, and 109c coupled between base station controller 101 and respective sector antenna systems 117a, 117b, and 117c (each of which may include one or more antennas), and memory 118 coupled to processor 101.

More particularly, each transceiver 109 may include a receiver and a transmitter. Each receiver may be configured to generate digital data streams corresponding to one or more transport data blocks received through the respective sector antenna system 117 from wireless terminals 200 located in a sector serviced by the respective sector antenna system in an uplink. Each transmitter may be configured to transmit one or more transport data blocks through the respective sector antenna system 117 in a downlink to wireless terminals 200 located in the sector serviced by the sector antenna system 117 responsive to a digital data stream from processor 101. Accordingly, base station 100 of FIG. 1 may define three 120 degree sectors A, B, and C surrounding the base station 100, transceiver 109a and sector antenna system 117a may support uplink/downlink communications for wireless terminals 200 in sector A of base station 100, transceiver 109b and sector antenna system 117b may support uplink/downlink communications for wireless terminals 200 in sector B of base station 100, and transceiver 109c and sector antenna system 117c may support uplink/downlink communications for wireless terminals 200 in sector C of base station 100.

FIG. 2B is a block diagram of base station controller 101 of FIG. 2A according to some embodiments. As shown, for example, base station controller 101 may include a processor 141, network interface 143, and transceiver interface 145. Network interface 143 may provide a communications interface between processor 141 and RNC 121 and/or between processor 141 and other base stations 100. Transceiver interface 145 may be configured to provide a communications interface between processor 141 and each of transceivers 109a, 109b, and 109c.

FIG. 2C is a block diagram of a radio network controller (RNC) 121 of FIG. 1 according to some embodiments. As shown, for example, the RNC 121 may include processor 131 and network interface 135. Network interface 135 may provide a communications interface between processor 131 and base stations 100 and/or between processor 131 and core network 70.

FIG. 2D is a block diagram of a wireless terminal (UE) 200 of FIG. 1 according to some embodiments. Wireless terminal 200, for example, may be a cellular radiotelephone, a smart phone, a laptop/netbook/tablet/handheld computer, or any other device providing wireless communications. Wireless terminal 200, for example, may include a processor 201, user interface 211 (e.g., including a visual display such as an liquid crystal display, a touch sensitive visual display, a keypad, a speaker, a microphone, etc.), memory 218, transceiver 209, and sector antenna system 217 (including a plurality of antenna elements). Moreover, transceiver 209 may include a receiver allowing processor 201 to receive downlink data from radio access network 60 over one or more wireless channels 300 through sector antenna system 217 and transceiver 209, and transceiver 209 may include a transmitter allowing processor 201 to transmit uplink data through transceiver 209 and sector antenna system 217 over one or more wireless channels 300 to radio access network 60.

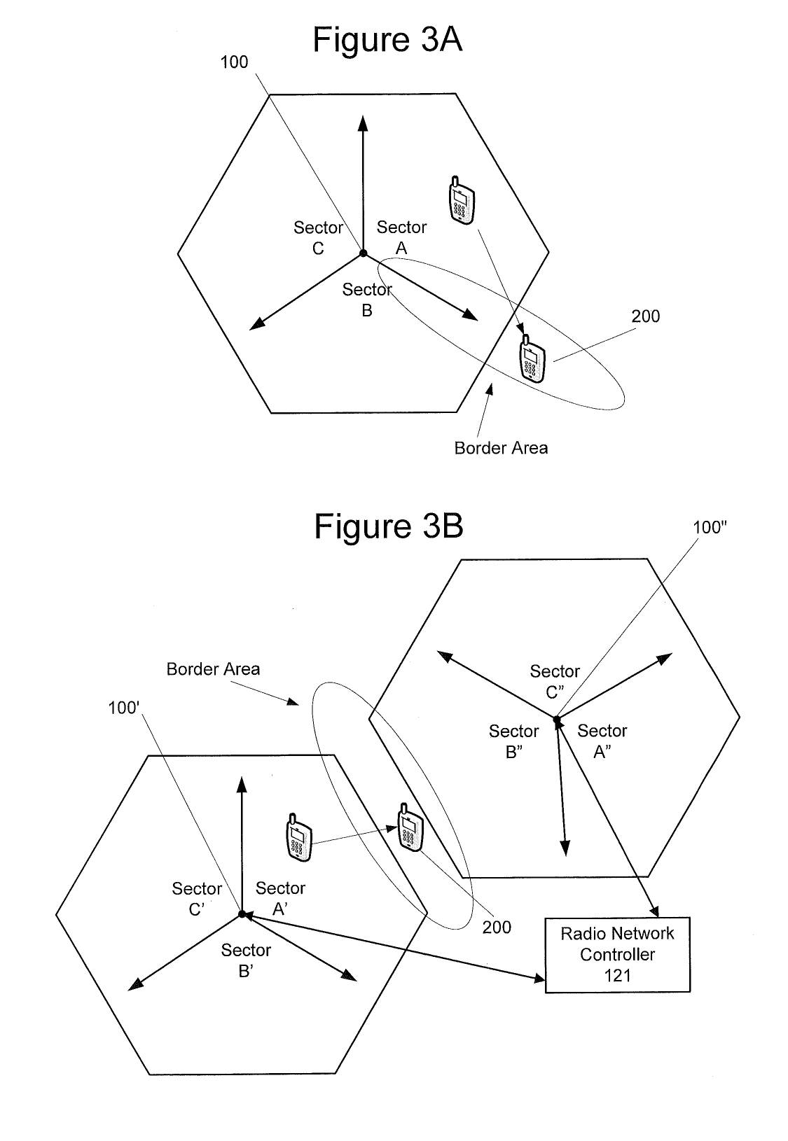

As shown in FIG. 3A, a base station 100 of FIG. 2A may support communications with wireless terminals 200 in three different 120-degree sectors A, B, and C. More particularly, transceiver 109a and sector antenna system 117a may support communications with wireless terminals 200 located in Sector A, transceiver 109b and sector antenna system 117b may support communications with wireless terminals 200 located in Sector B, and transceiver 109c and sector antenna system 117c may support communications with wireless terminals 200 located in Sector C. Stated in other words, each of sector antenna system 117a, 117b, and 117c (together with respective transceivers 109a, 109b, and 109c) defines a respective 120-degree sector A, B, and C. When wireless terminal 200 is initially located in a central portion of sector A as shown in FIG. 3A, wireless terminal 200 may transmit uplink communications that are received through sector antenna system 117a and transceiver 109a at base station 100.

A softer handover operation refers to an operation in which uplink transmissions from a wireless terminal 200 are received at different sectors/cells of a same base station 100. For example, when the wireless terminal 200 moves from a central portion of sector A to a softer handover area (also referred to as a border area) between sectors A and B as indicated by the arrow in FIG. 3A, intra node Multi-Flow communications may be used to receive the uplink communications through sector antenna system 117a and transceiver 109a at base station 100, and through sector antenna system 117b and transceiver 109b at base station 100. By receiving both first and second transport data blocks through both sectors when located in the softer handover area, reception thereof may be improved.

A soft handover operation, on the other hand, refers to an operation in which uplink transmissions from a wireless terminal 200 are received at sectors/cells of different base stations. For example, as shown in FIG. 3B, two base stations, identified as base stations 100′ and 100″, may support communications with wireless terminals 200, with each of base stations 100′ and 100″ separately having the structure of FIG. 2A (using prime and double prime notation to separately identify elements of the different base stations 100′ and 100″). In addition, each base station 100′ and 100″ may be coupled to RNC 121. Moreover, base stations 100′ may support communications with wireless terminals 200 located in 120-degree sectors A′, B′, and C′ surrounding base station 100′, and base station 100″ may support communications with wireless terminals 200 located in 120-degree sectors A″, B″, and C″ surrounding base station 100″. More particularly, transceiver 109a′ and sector antenna system 117a′ may support uplink communications with wireless terminals 200 located in Sector A′, transceiver 109b′ and sector antenna system 117b′ may support uplink communications with wireless terminals 200 located in Sector B′, and transceiver 109c′ and sector antenna system 117c′ may support uplink communications with wireless terminals 200 located in Sector C′. Similarly, transceiver 109a″ and sector antenna system 117a′ may support uplink communications with wireless terminals 200 located in Sector A″, transceiver 109b″ and sector antenna system 117b″ may support uplink communications with wireless terminals 200 located in Sector B″, and transceiver 109c″ and sector antenna system 117c″ may support uplink communications with wireless terminals 200 located in Sector C″. When a wireless terminal 200 is initially located in a central portion of sector A′ as shown in FIG. 3B, RAN 60 may provide wireless uplink communications by receiving transmissions from the wireless terminal 200 through sector antenna system 117a′ and transceiver 109a′.

When a wireless terminal 200 moves from a central portion of sector A′ to a border area between sectors A′ and B″ (of different base stations 100′ and 100″) as indicated by the arrow in FIG. 3B, RAN 60 may provide wireless uplink communications by receiving transmissions from wireless terminal 200 through sector antenna system 117a′ and transceiver 109a′ and through sector antenna system 117b″ and transceiver 109b″.

When wireless terminal 200 is in a border area between two sectors A′ and B″ of different base stations 100′ and 100″ as shown in FIG. 3B, all data streams from the wireless terminal 200 may be processed through a single radio network controller (RNC) 121. Diversity combining may thus be performed at radio network controller 121 and/or base stations 100′/100″ to provide improved reception from wireless terminal 200.

According to some embodiments of present inventive concepts, methods may provide improved WCDMA Uplinks, referred to as HSPA Enhanced Uplink (EUL). Rate adaptation methods are currently being studied in 3GPP as a means to achieve higher Uplink (UL) bit rates while maintaining system stability. Some embodiments of present inventive concepts may build on methods proposed in R1-131 608, “Introduction of SINR-based scheduling for HSUPA”, Nokia Siemens Networks, 3GPP RANI WG meeting, Chicago, Apr. 15-19, 2013, which proposes to base the inner loop power control on total received power (instead of control channel Signal to Interference Ratio (SIR), as has been done prior to R1-131 608), and by controlling the rate independently of the granted power. Some embodiments of present inventive concepts may improve methods proposed in R1-131 608, including operation in soft handover, network signaling, and protection of the control channel SIR.

Some embodiments of present inventive concepts relate to power control and bit rate adaptation in HSPA Enhanced Uplink (EUL). A UE that has been scheduled to use EUL may use three uplink physical channels:
(1) The Dedicated Physical Control Channel (DPCCH), which is used to transmit known pilot bits used by the NodeB for synchronization and channel estimation. In addition, it may include, for example, power control commands to be used in the downlink.
(2) The Enhanced Dedicated Channel (E-DCH) Dedicated Physical Data Channel (E-DPDCH), which carries the actual user data.
(3) The E-DCH Dedicated Physical Control Channel (E-DPCCH), which carries information about the format of the data sent on the E-DPDCH:
   a) E; DCH Transport Format Combination Indicator (ETFCI), from which the NodeB can determine the number of information bits, spreading factors, and modulation used in the transmission.
   b) The retransmission sequence number (RSN), which indicates which coded bits are sent.
   c) The so-called “happy bit,” which indicates if the UE would like to transmit at a higher rate.

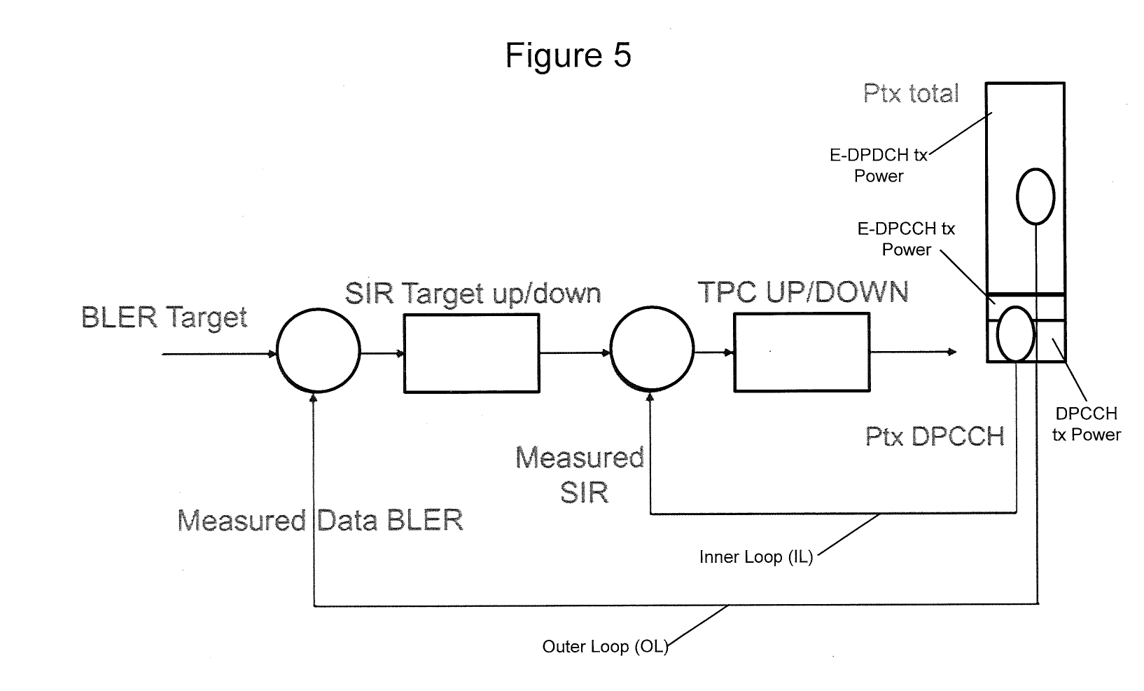

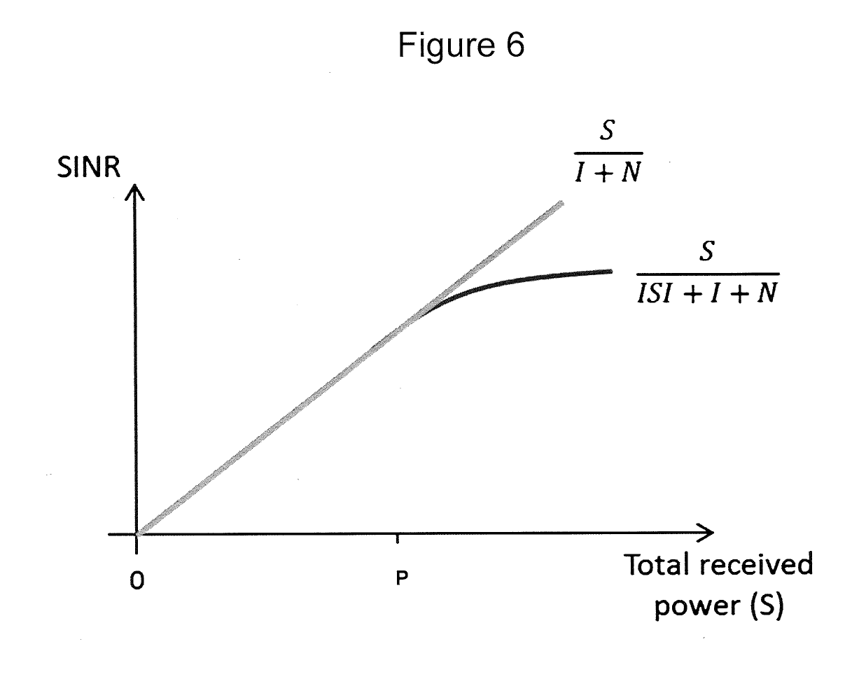

Fast uplink power control may be a significant feature of all CDMA systems because a plurality of users typically share the same air interface resource. Operations of inner and outer power control loops (ILPC and OLPC) are illustrated in FIG. 5. The ILPC is based on Transmit Power Control (TPC) commands that are transmitted from the NodeB to the UE each slot (2/3 milliseconds (ms)) ordering the UE to increase or decrease the power of the DPCCH channel. The power of the other uplink channels (E-DPCCH, E-DPDCH and HS-DPCCH, for example) are defined in relation to DPCCH (as illustrated in FIG. 6 and discussed in 3GPP TS 25.213 and 3GPP TS 25.214), so TPC commands serve normally to increase/decrease the total transmit power of the UE. The TPC commands are typically used to control the Signal to Interference+Noise Ratio (SINR) to a level where control and data channels can be reliably detected, for example, to achieve a certain Block Error Rate (BLER) for the E-DPDCH. The BLER control is done by an outer loop, as illustrated in FIG. 5, where the OLPC algorithm changes the SIR target based on measured BLER. 3GPP TS 25.213, as used herein, refers to “3rd Generation Partnership Project; Technical Specification Group Radio Access Network; Spreading and modulation (FDD) (Release 11),” V11.2.0 (2012-06). 3GPP TS 25.214, as used herein, refers to “3rd Generation Partnership Project; Technical Specification Group Radio Access Network; Physical layer procedures (FDD) (Release 11),” V11.2.0 (2012-06).

The UE bit rate is controlled by sending an Absolute (and relative) Grant (AG) to the UE at most once per Transmit Time Interval (TTI), which is 2 or 10 ms for EUL. The AG value provides the UE with an allowed power offset on the E-DPDCH channel relative to the DPCCH power. In addition, the granted value, together with other signaled parameters, determines the maximum bit rate the UE may use.

As described herein, in WCDMA uplink, the received power in the NodeB is a shared resource. The NodeB therefore tries to control the Rise over Thermal (RoT) power, which is the total received power divided by the thermal noise power. The higher the RoT becomes, the less stable the system becomes. Therefore, the NodeB scheduler takes into account the maximum allowed RoT when it determines the AG and DPCCH power for each UE. Based on the available power headroom for the UE, it sends an AG to the UE. As AGs are sent on a TTI basis, the total loop delay is considerably longer than the inner loop power control delay, and is at least 6 ms but could in practice be much longer. The scheduler measures the actual total received power of the UE and checks whether it is within the target power. If it is too large, then the grant is decreased. Otherwise, it may be increased.

The above procedure, however, can lead to RoT stability problems for many reasons. The measured SINR ratio depends, for example, on the type of receiver that is deployed. As an example, if an Interference Suppression receiver is used, then the resulting SINR depends in a complicated manner on the combination of the user's and other users' propagation channels and powers. For a user transmitting at high rates, which is equivalent to high SINRs and high power offset between E-DPDCH and DPCCH, the self-interference also starts to influence the SINR as illustrated in FIG. 6, which shows that above a certain power level P, an increase in total received power does not result in increased SINR, but rather flattens out. If the SINR target is above this level, then a power rush may occur. This power rush may then cause all other UEs in the cell (and also to some extent UEs in neighbor cells) to increase their powers to reach their SINR targets. This kind of power rush can also occur when a user (perhaps in a different cell) suddenly starts to transmit at a high rate, creating instantaneous increased RoT.

Eventually, the scheduler will detect that the RoT has surpassed the target and it will then transmit new reduced grants for the UEs within its control. However, as the granting mechanism is much slower (e.g., 10 times slower) than the ILPC, this may not be an easy task. Therefore, use of other emergency measures may be required, such as temporarily overriding the ILPC loops and forcing down the UE transmit power before the new grants have been be received. After the RoT has been reduced, the scheduler may again need to upgrant (i.e., increase the grant for) the users. If this is done in an aggressive manner, then, de facto, the system is operating in an on/off mode. Alternatively, the scheduler could act in an overly-conservative manner and only upgrant the users very slowly so as to avoid power rushes. Neither of these alternatives appears to use the full potential of the air interface.

Power rushes may be reduced/avoided by changing the power control algorithms that strive for a certain SINR and BLER level to instead aim at keeping a constant total received power level at the NodeB. Fluctuating power levels from unstable UEs can then be reduced/avoided, leading to a more predictable and stable system, as described above. To keep the BLER level at certain target, the rate may be adapted, which may be referred to as rate adaptation.

A philosophy of rate adaptation may be different from previous approaches. In previous approaches, the user is granted a certain rate and the SIR target is adapted to achieve a certain BLER level at that rate. In rate adaptation, the rate is adapted to give/maintain a certain/target BLER given a total power budget.

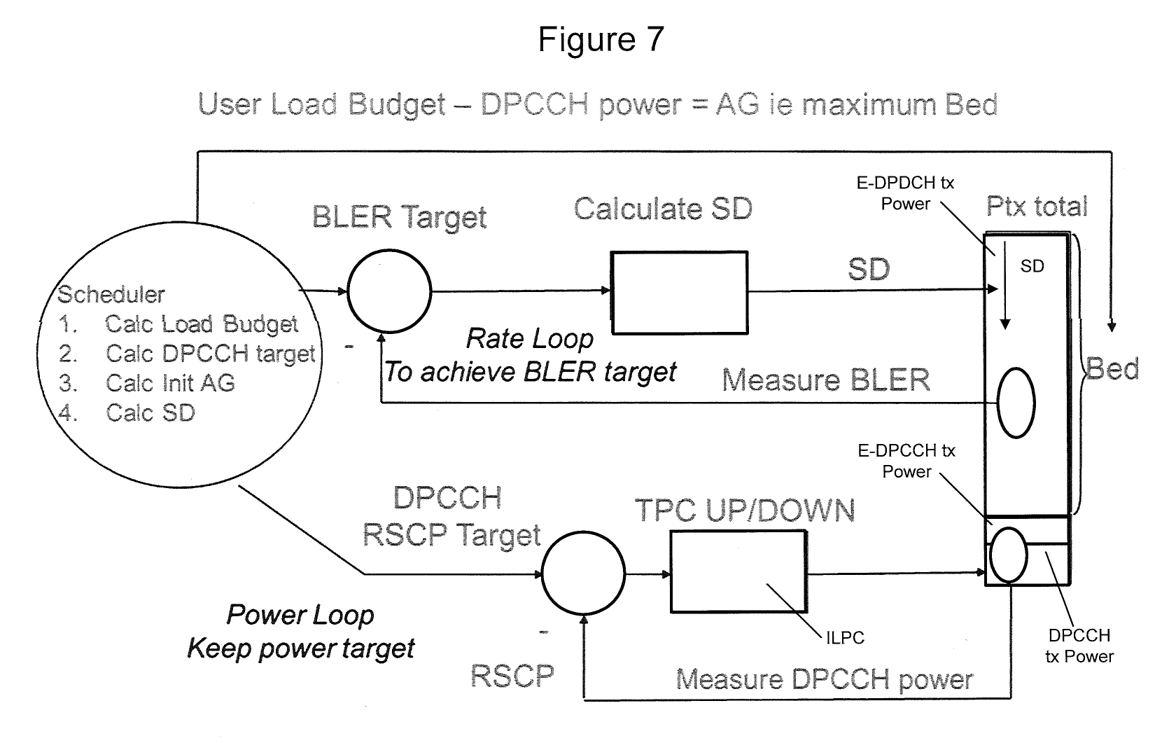

Some proposals for rate adaptation algorithms are discussed in R1-131 608 and illustrated in FIG. 7. Processes using the proposals may include:
1. The NodeB calculates a target total power Ec/N0 for the UE.
2. The NodeB calculates an initial grant AG and transmits the initial grant AG to the UE.
3. The received power on DPCCH is controlled by the ILPC to a target level that can be calculated based on the given total Ec/NO target and the granted power offset AG.
4. The NodeB transmits, on a new signaling channel, offsets SD to the granted rate given by the initial AG. The offsets are only used for increasing/reducing the rate, rather than to reduce the power offset of E-DPDCH relative to DPCCH. The total power is thus maintained. The offset is calculated, for example, by a step algorithm based on BLER statistics in the serving cell.

Some proposals regarding rate adaptation, however, may not work optimally in a soft handover. For example, the rate offset calculation is done in the serving NodeB, meaning that the decoding performance in the non-serving cell may not be taken into account. It may be the case, for example, that the non-serving cell can decode the UE transmissions much better than the serving cell, but the serving cell, without this knowledge, instead reduces the rate, hence reducing the gain of soft handover.

An additional complication may be the use of power based ILPC, because of which the quality of the control channel reception may not be guaranteed.

According to various embodiments of inventive concepts, the rate offset calculator may be in the RNC (e.g., rate offset calculations may be performed by RNC processor 131), at least when the UE is in soft handover. This may be advantageous because the RNC may have the best information available on the BLER statistics of all links in the active set.

To enable reliable power measurements in non-serving cells according to various embodiments of inventive concepts, the used AG (which is the granted power offset of the UE) may be signaled from the serving cell to the non-serving cells through the RNC. Moreover, to ensure reliable control channel decoding, a mechanism for temporary power control loop rate adaptation for the serving cell may be used.

Referring again to FIG. 7, the inner loop power control (ILPC) depicted in the lower part of FIG. 7 adapts the total received power from the UE on a slot basis using standardized TPC UP/DOWN commands. The received power of the DPCCH is measured by, for example, using the known pilots on the DPCCH. The total power can then be estimated by knowing the power used on E-DPCCH and E-DPDCH, which powers can be inferred from the AG and signaled parameters.

The rate offset calculation depicted in the upper part of FIG. 7 can be performed either in the NodeB alone, as in previous proposals, or according to present inventive concepts, when the UE is in soft handover, by the RNC.

In any case, the rate offset calculation may be based on BLER statistics. If the BLER is higher than the desired target, then the offset is decreased. Otherwise it is increased. The UE then decreases/increases the rate but maintains the relative power of data versus control.

An example of how the Rate Offset calculation can be done when implemented in the NodeB is provided below. Every TTI, a received data block is decoded and a Cyclic Redundancy Check (CRC) determines whether the block was correctly decoded or, alternatively, whether a HARQ restransmission is needed. If the received data block was an initial transmission, then the following Rate Offset update is made:

if CRC OK

Rate Offset=Rate Offset+0.1

else

Rate Offset=Rate Offset−0.9

end

The Rate Offset is rounded to the nearest lower integer. If the calculated rounded Rate Offset is different from the currently-used Rate Offset, then the new Rate Offset is transmitted to the UE on a dedicated physical channel.

It will be understood that the above algorithm is merely one non-limiting example. For example, it may also be useful to take into account the loop delay for the rate offset signaling in the calculations.

When the UE is in soft handover, performing the Rate Offset calculation function in the RNC may be advantageous because only the RNC has full knowledge about the HARQ retransmission performance from all cells in the active set. Accordingly, signaling may be defined between the RNC and a NodeB to carry the Rate Offset information.

Alternatively, existing procedures for outer loop power control may be used because these procedures may essentially be based on changing power (SIR target) based on HARQ retransmission statistics. In this way, the RNC does not need to be aware that the UE is operating in rate adaptation mode. The NodeB may, however, interpret the SIR target changes as rate change commands.

In either case, the Rate Offset calculation logic above may be modified slightly because the RNC may not be immediately informed when the NodeB decoding fails (e.g., CRC not OK). Instead, the NodeB notifies the RNC once it has correctly received the block, and adds information to RNC about how many HARQ transmissions were needed.

When a block is received in the RNC, a check of how many transmissions were needed is performed. If the received block was a retransmission, then:

Rate Offset=Rate Offset−0.9

else

Rate Offset=Rate Offset+0.1

end

The Rate Offset is rounded to the nearest lower integer. If the calculated rounded Rate Offset is different from the currently-used Rate Offset, then the new Rate Offset is transmitted to the serving NodeB.

In the serving NodeB, the Rate Offset is compared with the currently-used Rate Offset. If the calculated rounded Rate Offset is different from the currently-used Rate Offset, then the new Rate Offset is transmitted to the UE on a dedicated physical channel. Normally, the Rate Offset is an integer parameter.

It will be understood that it is not necessary to inform the non-serving cells about the used Rate Offset. This is so because the non-serving cell uses E-DPCCH decoding to determine the actual rate. Stated in other words, the UE communicates the actual rate for each uplink transmission using E-DPCCH.

For inner loop power control purposes, however, it may be necessary/useful to inform the non-serving cell about the granted power offset. For example, referring to FIG. 7, the non-serving NodeB may need knowledge about the AG to compute the total received power. Previously, this information may have been available only in the serving NodeB. In some embodiments described herein, the serving NodeB may signal the currently used AG (and possibly also the time instant of change, i.e., frame number and subframe number) to the RNC and the non-serving cells in a soft handover. This signaling may only need to be done when the AG changes. Moreover, in some embodiments, the AG may be determined at the RNC in a soft handover and transmitted to the serving and non-serving cells/base stations.

Although the inner loop power control is based on received total power, the SINR on the control channels may need to be monitored to ensure a minimum quality. This safety net or “SINR guard” may work such that when the SINR goes below a certain level, then the NodeB decreases the AG so that the DPCCH power increases. As the AG signaling takes a longer time to reach the UE, the NodeB may also increase the inner loop Ec/N0 target temporarily, before the new grant has taken effect. The NodeB may also need to notify the RNC so that it stops updating the Rate Offset during the time the “SINR guard” is active. Also, a reset/restart mechanism for the Rate Offset estimate in the RNC may be used in combination with “SINR guard” operation.

This SINR guard may only be necessary in the serving cell. If the UE is in soft handover, the serving cell may need to protect its HS-DPCCH channel, which is only decoded in the serving cell. If the UE is not in soft handover, then all channels in the serving cell may need to be protected by the SINR guard.

Provided below is an example of how an initial Ec/NO target and an AG can be calculated. It will be understood, however, that the NodeB may need to take additional constraints into account. To begin, it is assumed that the NodeB operates toward an RoT target and, by allocating a grant for a new UE, it strives to reach the RoT target. Accordingly:

RoTtarget=(E_{c}+RTWP)/N0 (Equation 1),

where E_{c} is the power allocated to the user, RTWP is the total received wideband power in the NodeB, and N0 is the thermal noise power. Therefore:

(E_{c}/N₀)=(RoTtarget−RoT) (Equation 2)

For the scheduling grant, the desired SIR on the control channel is modeled as:

initialSIR=E_{dpcch}/(RTWP−E_{c})*SF(DPCCH)*Nrx (Equation 3),

from which the desired E_{dpcch} can be derived. Next, the power of E-DPCCH can be calculated. The minimum power of E-DPCCH can easily be obtained using the parameter Δ_{EDPCCH}. This power is denoted E_{edpcch-min}. If E-DPCCH boosting is used, then:

E_{edpdch}/(E_{dpcch}+E_{edpcch})=T2TP (Equation 4),

from which follows that:

E_{edpcch}=E_{c}/(1+T2TP)−E_{dpcch} (Equation 5)

If this power is lower than E_{edpcch-min}, then:

E_{edpcch}=E_{edpcch-min} (Equation 6).

The E-DPDCH power can now easily be determined as:

E_{e-dpdch}=E_{c}−E_{dpcch}−E_{edpcch} (Equation 7).

And, finally, the absolute grant (AG) is the ratio between E_{e-dpdch} and E_{dpcch} so that:

AG=E_{e-dpdch}/E_{dpcch} (Equation 8).

Rate adaptation refers to a family of methods designed to stabilize WCDMA and EUL uplink performance by reducing/avoiding excessive power rushes. One proposal for rate adaptation algorithms is discussed in R1-131 608. Some embodiments of present inventive concepts add operations that allow rate adaptation and power-based inner loop power control to also work when the UE is in a soft handover. Furthermore, because only total received power is controlled, there is a risk of degraded control channel performance, and operations to ensure a minimum quality of control channels in the serving cell are therefore provided in some embodiments of present inventive concepts.

It will be understood that although a Relative Grant may work in a similar manner as an Absolute Grant, the Relative Grant can be sent from either of the serving and non-serving cells. For the serving cell, the Relative Grant is a dedicated message sent to the UE with a

Transmission Time Interval (TTI) that is the same as the TTI the UE is using for its EUL transmissions (2 or 10 ms). The Relative Grant sent from the serving cell contains two possible values (+1, or UP; and −1, or DOWN). It instructs the UE to increase or decrease its grant value index by 1 (which corresponds to approximately 1 decibel (dB) in power offset).

On the other hand, for the non-serving cell, the Relative Grant is a common resource that is transmitted to one or more UEs for which the cell is a non-serving cell. The TTI is always the same (e.g., 10 ms). The Relative Grant from the non-serving cell contains only one value (−1, or DOWN). In other words, the Relative Grant from the non-serving cell instructs the UE to decrease its grant value index by 1.

Accordingly, it will be understood that although an Absolute Grant may be sent from a serving cell to a non-serving cell via an RNC in some embodiments of present inventive concepts, in other embodiments, a Relative Grant may be transmitted from either one of the serving and non-serving cells to other cells in the active set via the RNC.

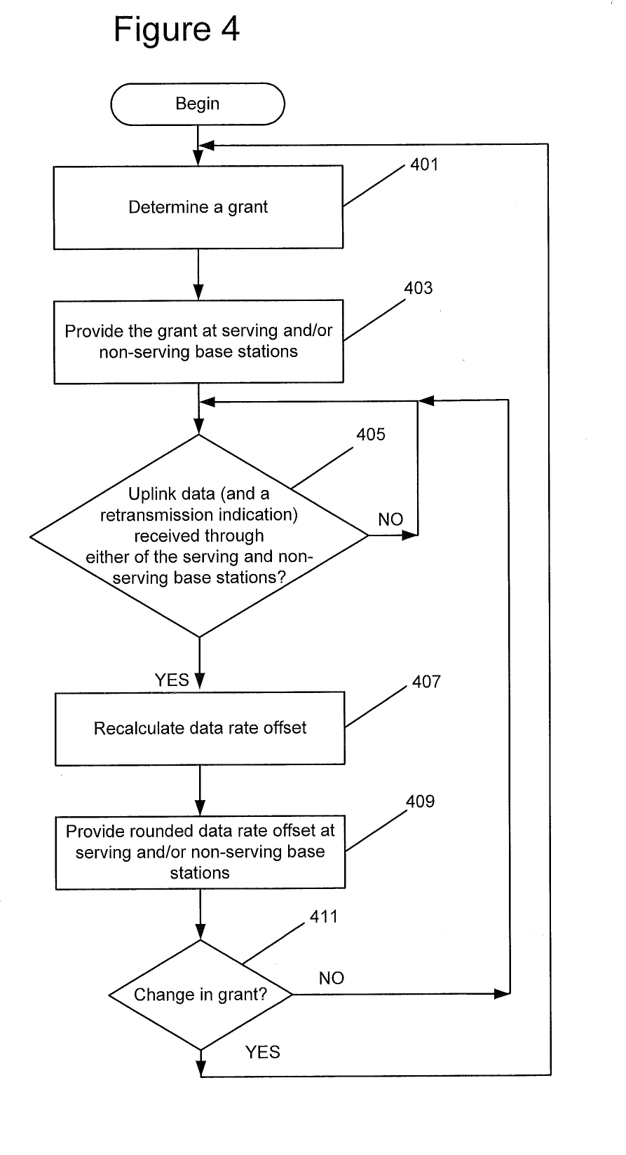

According to various embodiments of present inventive concepts, rate adaptation operations may be performed for a wireless terminal 200 that is in a soft handover with respect to a serving base station (e.g., the base station 100′) and a non-serving base station (e.g., the base station 100″). A base station may include a number of cells. For example, a serving base station may include one serving cell, and a non-serving base station may include at least one non-serving cell. According to some embodiments, multiple non-serving base stations may be provided. As shown in FIG. 4, operations of providing communications with the wireless terminal (200) through the serving and non-serving base stations (100′ and 100″) may include determining a grant (e.g., an AG) defining an uplink power offset for the wireless terminal (200) at Block 401.

At Block 403, the grant may be provided at the serving and/or non-serving base stations (100′ and 100″). For example, the grant may be determined by the serving base station (100′) and transmitted to the non-serving base station (100″) and a Radio Network Controller (121). In particular, the grant may be transmitted from the serving base station (100′) to the Radio Network Controller (121) and then transmitted from the Radio Network Controller (121) to the non-serving base station (100″), or may alternatively be transmitted directly from the serving base station (100′) to the non-serving base station (100″). According to other embodiments, the grant may be determined at the Radio Network Controller (121) and transmitted to the serving base station (100′) and the non-serving base station (100″). Moreover, in some embodiments, transmission of the grant, which grant may be used to determine a data rate, to the non-serving base station (100″) may not be necessary if an uplink data rate offset value is transmitted to the non-serving base station (100″).

The serving base station 100′ transmits the grant to the wireless terminal 200. The wireless terminal 200 receives the grant from the serving base station 100′, and the wireless terminal 200 may then determine its initial uplink data rate using the grant. The wireless terminal 200 may subsequently perform an initial uplink transmission using the initial uplink data rate. In particular, as the wireless terminal 200 is in a soft handover, both the serving base station 100′ and the non-serving base station 100″ will receive an uplink data block.

At Block 405, a retransmission indication is received through the non-serving base station (100″) or the serving base station (100′). Specifically, the retransmission indication includes an indication of a quantity of retransmissions of the uplink data block by the wireless terminal (200) to the one of the non-serving base station (100″) and the serving base station (100′) through which the retransmission indication is received in Block 405. The quantity of retransmissions of the uplink data block may be 0, 1, 3, or 4 (or more) retransmissions. The retransmission indication may be transmitted to the Radio Network Controller (121). In particular, it will be understood that although both the serving base station (100′) and the non-serving base station (100″) receive the uplink data block from the wireless terminal (200), the wireless terminal (200) may need to retransmit the uplink data block to the serving base station (100′) and/or the non-serving base station (100″) if the uplink data block is not successfully received/decoded (e.g., successful reception may mean passing CRC decoding) by one of the serving/non-serving base stations (100′/100″) responsive to the first transmission of the uplink data block. The first one of the serving base station (100′) and the non-serving base station (100″) to correctly receive and decode (e.g., as determined by passing a CRC) the uplink data block may transmit the uplink data block to the Radio Network Controller (121) along with the retransmission indication. The Radio Network Controller (121) may then determine a Block Error Rate (BLER) using the retransmission indication.

At Block 407, an uplink data rate offset value may be recalculated responsive to receiving the retransmission indication. For example, an uplink data rate offset value may be generated by the Radio Network Controller (121), and may be recalculated by the Radio Network Controller (121) until the recalculated uplink data rate offset value can be rounded to an uplink data rate offset value different from the uplink data rate offset value currently used by the Radio Network Controller (121).

At Block 409, the uplink data rate offset value may be provided at the serving base station (100′) for transmission to the wireless terminal (200). For example, the rounded uplink data rate offset value may be transmitted from the Radio Network Controller (121) to the serving base station (100′). The serving base station (100′) may then transmit this uplink data rate offset value to the wireless terminal (200), which may use the uplink data rate offset value to adjust its uplink data rate independently of adjusting its uplink power offset (e.g., grant). Moreover, it will be understood that the uplink data rate offset value may also be transmitted to the non-serving base station (100″). For example, as an alternative to sending the grant to the non-serving base station (100″), the Radio Network Controller (121) may transmit the rounded uplink data rate offset value to the non-serving base station (100″). Furthermore, if the functionality of the Radio Network Controller (121) is incorporated into the serving base station (100′), then the serving base station (100′) may generate the uplink data rate offset value and transmit the uplink data rate offset value to the non-serving base station (100″).

At Block 411, if the grant changes, then the updated grant will be provided at both the serving base station (100′) and the non-serving base station (100″) at Block 403, because the wireless terminal (200) is in a soft handover.

Referring still to FIG. 4, it will be understood that multiple iterations of the operations of some of the blocks therein (e.g., Blocks 405-409) will result in data rate offsets based on different uplink data blocks received from the wireless terminal 200 through different base stations 100′ and 100″. For example, referring to Block 405, the Radio Network Controller 121 may receive a first uplink data block from the wireless terminal 200 through the non-serving base station 100″ after a first quantity of uplink data block retransmissions of the first uplink data block by the wireless terminal 200, and the Radio Network Controller 121 may additionally receive a second/different uplink data block from the wireless terminal 200 through the serving base station 100′ after a second quantity of uplink data block retransmissions of the second uplink data block by the wireless terminal 200. Moreover, as multiple recalculations of the data rate offset in Block 407 may be needed before a rounded data rate offset (in Block 409) is different from a currently-used data rate offset, a new/changed data rate offset may be based on an aggregation of multiple different uplink data blocks received from the wireless terminal 200 through different base stations 100′ and 100″.

It will also be understood that the operations illustrated in FIG. 4 may be performed by components of the Radio Network Controller 121 and/or the serving base station 100′ illustrated in FIGS. 1-2C. For example, the serving base station 100′ may determine the grant at Block 401 using the processor 141′ of the base station controller 101′ illustrated in FIG. 2B. Alternatively, the Radio Network Controller 121 may determine the grant at Block 401 using the processor 131 of the Radio Network Controller 121 illustrated in FIG. 2C. At Block 403, the serving base station 100′ may use the network interface 143′ of the base station controller 101′ to transmit the grant to the network interface 135 of the Radio Network Controller 121. The network interface 135 of the Radio Network Controller 121 may additionally or alternatively be configured to transmit the grant to the network interface 143″ of the base station controller 101″ of the non-serving base station 100″.

At Block 405, uplink data blocks and retransmission indications may be received from the wireless terminal 200 through the respective network interfaces 143′ and 143″ of the serving and non-serving base stations 100′ and 100″. The uplink data blocks and retransmission indications may, in some embodiments, be transmitted from the respective network interfaces 143′ and 143″ of the serving and non-serving base stations 100′ and 100″ to the network interface 135 of the Radio Network Controller 121.

At Block 407, the processor 131 of the Radio Network Controller 121 may recalculate data rate offsets in response to receiving the uplink data blocks and retransmission indications. The processor 131 of the Radio Network Controller 121 may round the recalculated data rate offsets to an integer (e.g., round down to the closest integer). At Block 409, the network interface 135 of the Radio Network Controller 121 may transmit the rounded data rate offsets to the serving base station 100′. Alternatively, the processor 141′ of the base station controller 101′ of the serving base station 100′ may recalculate data rate offsets and round the recalculated data rate offsets. The network interface 143′ of the base station controller 101′ of the serving base station 100′ may transmit the rounded data rate offsets to the wireless terminal 200. Moreover, at Block 411, the processor 131 of the Radio Network Controller 121 and/or the processor 141′ of the base station controller 101′ of the serving base station 100′ may determine changes in grant.

Additionally, it will be understood that the wireless terminal 200 may transmit uplink data blocks, receive grants, and receive and implement data rate offsets using the processor 201, transceiver 209, and antenna system 217 illustrated in FIG. 2D.

In some embodiments, the data rate offset provided at the serving base station 100′ in Block 409 of FIG. 4 may be used together with a received E-TFCI on an E-DPCCH to calculate an E-TFCI′ that would have been chosen by the wireless terminal 200 if the data rate offset had not been applied. The calculated E-TFCI′ may then be used to determine the power used by the wireless terminal 200. In particular, the E-TFCI′ may be used to calculate the received load at the serving base station 100′ for data received (e.g., on an E-DPDCH) from the wireless terminal 200. Specifically, the E-TFCI′ may be used to determine the relative power between a DPCCH and the E-DPDCH to calculate the received load on the E-DPDCH.

Moreover, the data rate offset may be used together with an E-TFCI received by a non-serving base station 100″ on an E-DPCCH to calculate an E-TFCI′ that would have been chosen (e.g., selected/used) by the wireless terminal 200 if the data rate offset had not been applied. The E-TFCI′ may be used to calculate the received load at the non-serving base station 100″ for data received (e.g., on an E-DPDCH) from the wireless terminal 200. For example, the E-TFCI′ may be used to determine the relative power between a DPCCH and the E-DPDCH to calculate the received load on the E-DPDCH.

Accordingly, the serving and non-serving base stations 100′ and 100″ may each calculate an E-TFCI′ for every received E-TFCI, which may be received, for example, every 2 ms. Specifically, the serving and non-serving base stations 100′ and 100″ may each calculate an E-TFCI′ using the most recent data rate offset, along with each newly-received E-TFCI. The E-TFCI′ may correspond to a grant used by the wireless terminal 200. Moreover, even if the wireless terminal 200 is not using its full grant (e.g., the wireless terminal 200 may not have enough power or data to fully use the grant, and may thus use a reduced E-TFCI'), the serving and non-serving base stations 100′ and 100″ may still use the data rate offset to calculate the E-TFCI' that otherwise would have been chosen by the wireless terminal 200. For example, the wireless terminal 200 may be power limited, and thus may not be using its full grant. The value of the grant (e.g., an AG), however, can be used to determine whether the calculated E-TFCI′ is the same as an E-TFCI corresponding to the grant. If the two values are different, then it may be determined that the wireless terminal 200 is power limited or data limited.

In some embodiments, as a grant changes (e.g., as indicated in Block 411 of FIG. 4), it may be beneficial to determine a new/updated Received Signal Code Power (RSCP) target (e.g., as illustrated in the inner loop power control of FIG. 7). Moreover, such an updated RSCP target may be provided at the non-serving base station 100″, as well as the serving base station 100′. In particular, the Radio Network Controller 121 may receive an updated RSCP target from the serving base station 100′ after the grant changes in the serving base station 100′, and the Radio Network Controller 121 may then transmit the updated RSCP target to the serving and non-serving base stations 100′ and 100″. For example, the Radio Network Controller 121 may simultaneously transmit the updated RSCP target to the serving and non-serving base stations 100′ and 100″. Similarly, it will be understood that the Radio Network Controller 121 may receive an initial RSCP target (e.g., preceding the updated RSCP target) from the serving base station 100′, and the Radio Network Controller 121 may then simultaneously transmit the initial RSCP target to the serving and non-serving base stations 100′ and 100″.

One example in which updating the RSCP target from the serving base station 100′ to the Radio Network Controller 121 may be beneficial is when the SIR decreases too much for reliable control channel decoding (e.g., HS-DPCCH) in the serving base station 100′. Accordingly, RSCP target adjustments may be considered gradual adjustments (e.g., adjustments up (positive) or down (negative)) toward a target SIR. Moreover, such RSCP target adjustments may be linked to corresponding changes in grant, and may thus help to maintain a target total power.

### Examples of Embodiments

1. A method of providing communications with a wireless terminal (200) through serving and non-serving base stations (100′ and 100″), the method comprising:
receiving (405) a retransmission indication through the non-serving base station (100″) or the serving base station (100′), wherein the retransmission indication comprises an indication of a quantity of uplink data block retransmissions by the wireless terminal (200) to the non-serving base station (100″) or the serving base station (100′);
generating (407) an uplink data rate offset value responsive to the retransmission indication;
providing (409) the uplink data rate offset value at the non-serving base station (100″); and
providing (409) the uplink data rate offset value at the serving base station (100′) for transmission to the wireless terminal (200).

2. The method of embodiment 1, wherein providing (409) the uplink data rate offset value comprises transmitting the uplink data rate offset value from a Radio Network Controller (121) to the serving base station (100′) for transmission to the wireless terminal (200), and transmitting the uplink data rate offset value from the Radio Network Controller (121) to the non-serving base station (100″).

3. The method of embodiment 1,
wherein generating (407) the uplink data rate offset value comprises:
   recalculating an initial data rate offset value responsive to the retransmission indication;
   rounding the recalculated data rate offset value; and
   comparing the rounded data rate offset value with the initial data rate offset value, and
wherein providing (409) the uplink data rate offset value comprises providing the rounded data rate offset at the serving and non-serving base stations (100′ and 100″) in response to determining that the rounded offset value is different from the initial data rate offset value.

4. The method of embodiment 3, wherein providing (409) the rounded data rate offset value comprises transmitting the rounded data rate offset value from a Radio Network Controller (121) to the serving and non-serving base stations (100′ and 100″).

5. The method of embodiment 1, further comprising:
determining that a Signal-to-Interference-plus-Noise Ratio (SINR) of the serving base station (100′) is below a threshold level;
providing a determination to decrease a grant in response to determining that the SINR is below the threshold level, wherein the grant indicates an uplink power offset for the wireless terminal (200); and
increasing a target uplink power level of the wireless terminal (200) responsive to determining that the SINR is below the threshold level and before the grant decreases at the wireless terminal (200).

6. The method of embodiment 5, further comprising:
transmitting an indication of the target uplink power level of the wireless terminal (200) from a Radio Network Controller (121) to the non-serving base station (100″).

7. The method of embodiment 1, further comprising:
providing a determination to temporarily increase a Dedicated Physical Control Channel, DPCCH, transmit power of the wireless terminal (200) while maintaining a constant uplink data rate.

8. The method of embodiment 1,
wherein receiving (405) the retransmission indication comprises:
   receiving a first uplink data block from the wireless terminal (200) through the non-serving base station (100″) after a first quantity of uplink data block retransmissions of the first uplink data block by the wireless terminal (200); and
   receiving a second uplink data block from the wireless terminal (200) through the serving base station (100′) after a second quantity of uplink data block retransmissions of the second uplink data block by the wireless terminal (200), and wherein generating (407) the uplink data rate offset value comprises:
   generating a first adjustment value based on the first quantity of uplink data block retransmissions; and
   generating a second adjustment value based on the second quantity of uplink data block retransmissions.

9. A method of providing communications with a wireless terminal (200) through serving and non-serving base stations (100′ and 100″), the method comprising:
receiving (405) a retransmission indication through the non-serving base station (100″) or the serving base station (100′), wherein the retransmission indication comprises an indication of a quantity of uplink data block retransmissions by the wireless terminal (200) to the non-serving base station (100″) or the serving base station (100′);
generating a signal-to-interference ratio, SIR, value responsive to the retransmission indication;
providing (409) an uplink data rate offset value at the non-serving base station (100″) responsive to the SIR value; and
providing (409) the uplink data rate offset value at the serving base station (100′) responsive to the SIR value for transmission to the wireless terminal (200).

10. The method of embodiment 9, wherein providing (409) the uplink data rate offset value at the serving base station (100′) comprises transmitting the SIR value from a Radio Network Controller (121) to the serving base station (100′), wherein the serving base station (100′) is configured to generate the uplink data rate offset value responsive to the SIR value.

11. A method of providing communications with a wireless terminal (200) through first and second base stations (100′ and 100″), the method comprising:
providing (405) a first uplink data block from the wireless terminal (200) wherein the first uplink data block is received from the wireless terminal (200) through the first base station (100′);
providing (405) a first retransmission indication indicating a number of retransmissions of the first uplink data block received through the first base station (100′) from the wireless terminal (200);
providing (405) a second uplink data block from the wireless terminal (200) wherein the second uplink data block is received from the wireless terminal (200) through the second base station (100″);
providing (405) a second retransmission indication indicating a number of retransmissions of the second uplink data block received through the second base station (100″) from the wireless terminal (200);
generating (407) a data rate offset value for the wireless terminal responsive to the first and second retransmission indications wherein the data rate offset value indicates a change of an uplink data rate for the wireless terminal; and providing the data rate offset value to the wireless terminal (200).

12. The method of embodiment 11 wherein the first base station (100′) comprises a serving base station (100′) and the second base station (100″) comprises a non-serving base station (100″), and wherein the first and second data blocks comprise first and second data blocks of a soft/softer handover communication with the wireless terminal (200).

13. The method of any one of embodiments 11-12 wherein the second data block is received from the wireless terminal (200) through the second base station (100″) at a data rate, and wherein the data rate offset value indicates a change of the uplink data rate for the wireless terminal (200) relative to the data rate of the second data block.

14. The method of any one of embodiments 11-13,
wherein generating (407) the data rate offset value comprises:
selecting a first adjustment value responsive to the first retransmission indication;
selecting a second adjustment value responsive to the second retransmission indication; and
combining the first and second adjustment values with an initial data rate offset value to provide a new data rate offset value, and
wherein providing the data rate offset value comprises providing the new data rate offset value to the wireless terminal (200).

15. The method of embodiment 14 wherein the first retransmission indication indicates receipt of an initial transmission of the first data block through the first base station without retransmission of the first data block, wherein the second retransmission indication indicates receipt of a retransmission of the second data block through the second base station after an initial transmission of the second data block, and wherein the first and second adjustment values are different.

16. The method of embodiment 15 wherein one of the first and second adjustment values is positive and wherein one of the first and second adjustment values is negative.

17. The method of embodiment 15 wherein the first adjustment value is positive and the second adjustment value is negative.

18. The method of any one of embodiments 15-17 wherein a magnitude of the first adjustment value is less than a magnitude of the second adjustment value.

19. The method of any one of embodiments 11-18, further comprising determining a received load at the first base station (100′) for data received from the wireless terminal (200), using the data rate offset value and a received Enhanced Dedicated Channel (E-DCH) Transport Format Combination Indicator (ETFCI).

20. The method of any one of embodiments 11-19, further comprising determining a received load at the second base station (100″) for data received from the wireless terminal (200), using the data rate offset value and a received Enhanced Dedicated Channel (E-DCH) Transport Format Combination Indicator (ETFCI).

21. The method of any one of embodiments 11-18, further comprising providing an indication of a target power level at the serving and non-serving base stations (100′ and 100″).

22. The method of embodiment 21, wherein providing the indication of the target power level comprising transmitting the indication of the target power level from the Radio Network Controller (121) to the serving and non-serving base stations (100′ and 100″).

23. The method of any one of embodiments 21 and 22, further comprising transmitting the indication of the target power level from the serving base station (100′) to the Radio Network Controller (121) before providing the indication of the target power level at the serving and non-serving base stations (100′ and 100″).

24. The method of any one of embodiments 11-23, wherein providing the data rate offset value comprises:
providing (409) the data rate offset value at the non-serving base station (100″); and
providing (409) the data rate offset value at the serving base station (100′) for transmission to the wireless terminal (200).

25. The method of embodiment 24, wherein providing (409) the data rate offset value comprises transmitting the data rate offset value from a Radio Network Controller (121) to the serving base station (100′) for transmission to the wireless terminal (200), and transmitting the data rate offset value from the Radio Network Controller (121) to the non-serving base station (100″).

26. A node (121) of a radio access network (60) configured to provide communications with a wireless terminal (200) through first and second base stations (100′ and 100″), the node (121) comprising:
a network interface (135) configured to provide communications with the first and second base stations (100′ and 100″); and
a processor (131) coupled to the network interface (135) wherein the processor (131) is configured to:
   provide a first uplink data block from the wireless terminal (200) wherein the first uplink data block is received through the first base station (100′) and the network interface (135) from the wireless terminal (200),
   provide a first retransmission indication indicating a number of retransmissions of the first data uplink block received through the first base station (100′) from the wireless terminal (200),
   provide a second uplink data block from the wireless terminal (200) wherein the second uplink data block is received through the second base station (100″) and the network interface from the wireless terminal (200),
   provide a second retransmission indication indicating a number of retransmissions of the second uplink data block received through the second base station (100″) from the wireless terminal (200),
   generate a data rate offset value for the wireless terminal (200) responsive to the first and second retransmission indications wherein the data rate offset value indicates a change of an uplink data rate for the wireless terminal (200), and
   provide the data rate offset value to the wireless terminal (200) through the network interface (135) and through at least one of the first and/or second base stations (100′ and 100″).

27. A node (121) of a radio access network (60) configured to provide communications with a wireless terminal (200) through serving and non-serving base stations (100′ and 100″), the node (121) comprising:
a network interface (135) configured to provide communications with the serving and non-serving base stations (100′ and 100″); and
a processor (131) coupled to the network interface (135) wherein the processor (131) is configured to:
   receive (405) a retransmission indication through the non-serving base station (100″) or the serving base station (100′), wherein the retransmission indication comprises an indication of a quantity of uplink data block retransmissions by the wireless terminal (200) to the non-serving base station (100″) or the serving base station (100′);
   generate (407) an uplink data rate offset value responsive to the retransmission indication;
   provide (409) the uplink data rate offset value at the non-serving base station (100″); and
   provide (409) the uplink data rate offset value at the serving base station (100′) for transmission to the wireless terminal (200).

### Examples of Embodiments in a Node (121)

According to some embodiments, a method to provide communications with a wireless terminal (200) in a soft handover may be provided. The method may include receiving (405), when the wireless terminal (200) is in the soft handover with respect to a serving base station (100′) and a non-serving base station (100″), a retransmission indication through the non-serving base station (100″) or the serving base station (100′). The method may include generating (407) an uplink data rate offset value responsive to the retransmission indication. Moreover, the method may include transmitting (409) the uplink data rate offset value to the serving base station (100′) for transmission to the wireless terminal (200).

The method may include transmitting (409) the uplink data rate offset value to the non-serving base station (100″).

The retransmission indication may include an indication of a quantity of uplink data block retransmissions by the wireless terminal (200) to the non-serving base station (100″) or the serving base station (100′).

Transmitting (409) the uplink data rate offset value may include transmitting the uplink data rate offset value from a Radio Network Controller (121).

Generating (407) the uplink data rate offset value may include recalculating an initial data rate offset value responsive to the retransmission indication, rounding the recalculated data rate offset value, and comparing the rounded data rate offset value with the initial data rate offset value. Moreover, transmitting (409) the uplink data rate offset value may include transmitting the rounded data rate offset in response to determining that the rounded offset value is different from the initial data rate offset value.

The method may include determining that a Signal-to-Interference-plus-Noise Ratio (SINR) of the serving base station (100′) is below a threshold level. The method may include providing a determination to decrease a grant in response to determining that the SINR is below the threshold level. The grant may indicate an uplink power offset for the wireless terminal (200). Moreover, the method may include increasing a target uplink Dedicated Physical Control Channel, DPCCH, power level of the wireless terminal (200) responsive to determining that the SINR is below the threshold level and before the grant decreases at the wireless terminal (200).

The method may include transmitting an indication of the target uplink Dedicated Physical Control Channel, DPCCH, power level of the wireless terminal (200) from a Radio Network Controller (121) to the non-serving base station (100″).

Determining that the SINR of the serving base station (100′) is below the threshold level may include determining that a SINR of one or more channels of the serving base station (100′) is below the threshold level.

The method may include providing a determination to increase (e.g., temporarily increase) a Dedicated Physical Control Channel, DPCCH, transmit power of the wireless terminal (200) while maintaining a constant uplink data rate.

Generating (407) the uplink data rate offset value may include generating a signal-to-interference ratio, SIR, target value responsive to the retransmission indication, and transmitting (409) the uplink data rate offset value may include transmitting the SIR target value.

Transmitting (409) the uplink data rate offset value may include transmitting the SIR target value from a Radio Network Controller (121) to the serving base station (100′). The serving base station (100′) may be configured to generate the uplink data rate offset value responsive to the SIR target value.

The method may include transmitting an indication of a target power level from a Radio Network Controller (121) to the non-serving base station (100″).

According to some embodiments, a node (121) of a radio access network (60) configured to provide communications with a wireless terminal (200) in a soft handover may be provided. The node (121) may include a network interface (135) configured to provide communications with a serving base station (100′) and a non-serving base station (100″). The node (121) may include a processor (131) coupled to the network interface (135). The processor (131) may be configured to receive (405), when the wireless terminal (200) is in a soft handover with respect to the serving base station (100′) and the non-serving base station (100″), a retransmission indication through the network interface (135) from the non-serving base station (100″) or the serving base station (100′). The processor (131) may be configured to generate (407) an uplink data rate offset value responsive to the retransmission indication. Moreover, the processor (131) may be configured to transmit (409) the uplink data rate offset value to the serving base station (100′) for transmission to the wireless terminal (200).

The processor (131) may be configured to transmit (409) the uplink data rate offset value through the network interface (135) to the non-serving base station (100″).

The retransmission indication may include an indication of a quantity of uplink data block retransmissions from the wireless terminal (200) to the non-serving base station (100″) or the serving base station (100′).

The processor (131) may be configured to transmit an indication of a target power level through the network interface (135) to the non-serving base station (100″).

### Examples of Embodiments in a Node (100′)

According to some embodiments, a method in a node (100′) may be provided. The method may include receiving (409) from a Radio Network Controller (121) an uplink data rate offset value used to adjust an uplink data rate of a wireless terminal (200), when the wireless terminal (200) is in a soft handover. Moreover, the method may include transmitting (409) the uplink data rate offset value to the wireless terminal (200) when the wireless terminal (200) is in the soft handover.

The node (100′) may be a serving base station (100′), the soft handover may be a soft handover with respect to the serving base station (100′) and a non-serving base station (100″), and wherein transmitting (409) the uplink data rate offset value may include transmitting (409) the uplink data rate offset value to the wireless terminal (200) when the wireless terminal (200) is in the soft handover with respect to the serving base station (100′) and the non-serving base station (100″).

The method may include receiving (405) from the wireless terminal (200) an uplink data block, and transmitting (405) to the Radio Network Controller (121) a retransmission indication that indicates a quantity of retransmissions of the uplink data block by wireless terminal (200).

Transmitting (409) the uplink data rate offset value may include comparing the uplink data rate offset value with an initial uplink data rate offset value, and transmitting the uplink data rate offset value to the wireless terminal (200) in response to determining that the uplink data rate offset value is different from the initial uplink data rate offset value.

The uplink data rate offset value may include a rounded uplink data rate offset value, and receiving (409) the uplink data rate offset value may include receiving (409) from the Radio Network Controller (121) the rounded uplink data rate offset value.

Receiving and transmitting (409) the uplink data rate offset value may include receiving from the Radio Network Controller (121) a signal-to-interference ratio, SIR, target value. Receiving and transmitting (409) the uplink data rate offset value may include generating the uplink data rate offset value in response to receiving the SIR target value. Moreover, receiving and transmitting (409) the uplink data rate offset value may include transmitting the uplink data rate offset value to the wireless terminal (200), after generating the uplink data rate offset value in response to receiving the SIR target value.

According to some embodiments, a node (100′) of a radio access network (60) configured to provide communications with a wireless terminal (200) may be provided. The node (100′) may include transceiver circuitry (109/145) configured to provide communications with the wireless terminal (200). The node (100′) may include a network interface (143) configured to provide communications with a Radio Network Controller (121). Moreover, the node (100′) may include a processor (141) coupled to the transceiver circuitry (109/145) and the network interface (143). The processor (141) may be configured to receive (409), through the network interface (143), from the Radio Network Controller (121) an uplink data rate offset value used to adjust an uplink data rate of the wireless terminal (200), when the wireless terminal (200) is in a soft handover. Moreover, the processor (141) may be configured to transmit (409) the uplink data rate offset value through the transceiver circuitry (109/145) to the wireless terminal (200) when the wireless terminal (200) is in the soft handover.

The node (100′) may be a serving base station (100′), the soft handover may be a soft handover with respect to the serving base station (100′) and a non-serving base station (100″), and wherein the processor (141) may be configured to transmit (409) the uplink data rate offset through the transceiver circuitry (109/145) to the wireless terminal (200) when the wireless terminal (200) is in the soft handover with respect to the serving base station (100′) and the non-serving base station (100″).

The processor (141) may be configured to receive (405) from the wireless terminal (200) an uplink data block through the transceiver circuitry (109/145). The processor (141) may be configured to transmit (405), through the network interface (143), to the Radio Network Controller (121) a retransmission indication that indicates a quantity of retransmissions of the uplink data block by wireless terminal (200).

The processor (141) may be configured to compare the uplink data rate offset value with an initial uplink data rate offset value. Moreover, the processor (141) may be configured to transmit (409) the uplink data rate offset value to the wireless terminal (200) through the transceiver circuitry (109/145) in response to determining that the uplink data rate offset value is different from the initial uplink data rate offset value.

The uplink data rate offset value may be a rounded uplink data rate offset value, and the processor (141) may be configured to receive (409), through the network interface (143), from the Radio Network Controller (121) the rounded uplink data rate offset value.

The processor (141) may be configured to receive (409), through the network interface (143), from the Radio Network Controller (121) a signal-to-interference ratio, SIR, target value. The processor (141) may be configured to generate (409) the uplink data rate offset value in response to receiving the SIR target value. Moreover, the processor (141) may be configured to transmit (409) the uplink data rate offset value to the wireless terminal (200) through the transceiver circuitry (109/145), after generating the uplink data rate offset value in response to receiving the SIR target value.

### Examples of Embodiments in a Wireless Terminal (200)

According to some embodiments, a method in a wireless terminal (200) may be provided. The method may include transmitting (405) an uplink data block to a non-serving base station (100″) and/or a serving base station (100′) when the wireless terminal (200) is in a soft handover with respect to the serving base station (100′) and the non-serving base station (100″). The method may then include receiving (409), through the serving base station (100′), an uplink data rate offset value generated by a Radio Network Controller (121) used to adjust an uplink data rate of the wireless terminal (200), when the wireless terminal (200) is in the soft handover.

Transmitting (405) the uplink data block may include transmitting, to the non-serving base station (100″) and/or the serving base station (100′), the uplink data block and a retransmission indication including an indication of a quantity of retransmissions of the uplink data block by the wireless terminal (200) to the non-serving base station (100″) and/or the serving base station (100′).

The wireless terminal (200) may include a wireless terminal (200) scheduled to communicate using Enhanced Uplink, EUL.

According to some embodiments, a wireless terminal (200) may be provided. The wireless terminal (200) may include a transceiver (209) configured to provide communications with a non-serving base station (100″) and a serving base station (100′). Moreover, the wireless terminal (200) may include a processor (201) coupled to the transceiver (209). The processor (201) may be configured to transmit (405), through the transceiver (209), an uplink data block to the non-serving base station (100″) and/or the serving base station (100′) when the wireless terminal (200) is in a soft handover with respect to the serving base station (100′) and the non-serving base station (100″). Moreover, the processor (201) may be configured to then receive (409), through the transceiver (209), from the serving base station (100′), an uplink data rate offset value generated by a Radio Network Controller (121) used to adjust an uplink data rate of the wireless terminal (200), when the wireless terminal (200) is in the soft handover.

The processor (201) may be configured to transmit (405), to the non-serving base station (100″) and/or the serving base station (100′), the uplink data block and a retransmission indication including an indication of a quantity of retransmissions of the uplink data block by the wireless terminal (200) to the non-serving base station (100″) and/or the serving base station (100′).

The wireless terminal (200) may be a wireless terminal (200) scheduled to communicate using Enhanced Uplink, EUL.

In the above-description of various embodiments of present inventive concepts, it is to be understood that the terminology used herein is for the purpose of describing particular embodiments only and is not intended to be limiting of inventive concepts. Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

It will be understood that, although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, elements, steps, components or functions but does not preclude the presence or addition of one or more other features, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit (also referred to as a processor) of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of present inventive concepts. All such variations and modifications are intended to be included herein within the scope of present inventive concepts. Accordingly, the above-disclosed subject matter is to be considered illustrative, and not restrictive, and the following claims are intended to cover all such modifications, enhancements, and other embodiments, which fall within the spirit and scope of present inventive concepts.

1-34. (canceled)

35. A method to provide communications with a wireless terminal in a soft handover, the method comprising:
receiving, when the wireless terminal is in the soft handover with respect to a serving base station and a non-serving base station, a retransmission indication through the non-serving base station or the serving base station;
generating an uplink data rate offset value responsive to the retransmission indication; and
transmitting the uplink data rate offset value to the serving base station for transmission to the wireless terminal.

36. The method of claim 35,
wherein the method further comprises transmitting the uplink data rate offset value to the non-serving base station.

37. The method of claim 35, wherein the retransmission indication comprises an indication of a quantity of uplink data block retransmissions by the wireless terminal to the non-serving base station or the serving base station.

38. The method of claim 35, wherein transmitting the uplink data rate offset value comprises transmitting the uplink data rate offset value from a Radio Network Controller.

39. The method of claim 35,
wherein generating the uplink data rate offset value comprises:
recalculating an initial data rate offset value responsive to the retransmission indication;
rounding the recalculated data rate offset value; and
comparing the rounded data rate offset value with the initial data rate offset value, and
wherein transmitting the uplink data rate offset value comprises transmitting the rounded data rate offset in response to determining that the rounded offset value is different from the initial data rate offset value.

40. The method of claim 35, further comprising:
determining that a Signal-to-Interference-plus-Noise Ratio (SINR) of the serving base station is below a threshold level;
providing a determination to decrease a grant in response to determining that the SINR is below the threshold level, wherein the grant indicates an uplink power offset for the wireless terminal; and
increasing a target uplink Dedicated Physical Control Channel, DPCCH, power level of the wireless terminal responsive to determining that the SINR is below the threshold level and before the grant decreases at the wireless terminal.

41. The method of claim 40, further comprising:
transmitting an indication of the target uplink Dedicated Physical Control Channel, DPCCH, power level of the wireless terminal from a Radio Network Controller to the non-serving base station.

42. The method of claim 40, wherein determining that the SINR of the serving base station is below the threshold level comprises determining that a SINR of one or more channels of the serving base station is below the threshold level.

43. The method of clam 35, further comprising:
providing a determination to increase a Dedicated Physical Control Channel, DPCCH, transmit power of the wireless terminal while maintaining a constant uplink data rate.

44. The method of claim 35,
wherein generating the uplink data rate offset value comprises generating a signal-to-interference ratio, SIR, target value responsive to the retransmission indication, and
wherein transmitting the uplink data rate offset value comprises transmitting the SIR target value.

45. The method of claim 44,
wherein transmitting the uplink data rate offset value comprises transmitting the SIR target value from a Radio Network Controller to the serving base station, and
wherein the serving base station is configured to generate the uplink data rate offset value responsive to the SIR target value.

46. The method of claim 35, further comprising:
transmitting an indication of a target power level for the wireless terminal from a Radio Network Controller to the non-serving base station.

47. A node of a radio access network configured to provide communications with a wireless terminal in a soft handover, the node comprising:
a network interface configured to provide communications with a serving base station and a non-serving base station; and
a processor coupled to the network interface wherein the processor is configured to:
receive, when the wireless terminal is in a soft handover with respect to the serving base station and the non-serving base station, a retransmission indication through the network interface from the non-serving base station or the serving base station;
generate an uplink data rate offset value responsive to the retransmission indication; and
transmit the uplink data rate offset value to the serving base station for transmission to the wireless terminal.

48. The node of claim 47, wherein the processor is further configured to transmit the uplink data rate offset value through the network interface to the non-serving base station.

49. The node of claim 47, wherein the retransmission indication comprises an indication of a quantity of uplink data block retransmissions from the wireless terminal to the non-serving base station or the serving base station.

50. The node of claim 47, wherein the processor is configured to transmit an indication of a target power level for the wireless terminal through the network interface to the non-serving base station.

51. A method in a node, the method comprising:
receiving from a Radio Network Controller an uplink data rate offset value used to adjust an uplink data rate of a wireless terminal, when the wireless terminal is in a soft handover; and
transmitting the uplink data rate offset value to the wireless terminal when the wireless terminal is in the soft handover.

52. The method of claim 51,
wherein the node comprises a serving base station,
wherein the soft handover comprises a soft handover with respect to the serving base station and a non-serving base station, and
wherein transmitting the uplink data rate offset value comprises transmitting the uplink data rate offset value to the wireless terminal when the wireless terminal is in the soft handover with respect to the serving base station and the non-serving base station.

53. The method of claim 51, further comprising:
receiving from the wireless terminal an uplink data block; and
transmitting to the Radio Network Controller a retransmission indication that indicates a quantity of retransmissions of the uplink data block by wireless terminal.

54. The method of claim 51, wherein transmitting the uplink data rate offset value comprises:
comparing the uplink data rate offset value with an initial uplink data rate offset value; and
transmitting the uplink data rate offset value to the wireless terminal in response to determining that the uplink data rate offset value is different from the initial uplink data rate offset value.

55. The method of claim 51,
wherein the uplink data rate offset value comprises a rounded uplink data rate offset value, and
wherein receiving the uplink data rate offset value comprises receiving the rounded uplink data rate offset value from the Radio Network Controller.

56. The method of claim 51, wherein receiving and transmitting the uplink data rate offset value comprises:
receiving from the Radio Network Controller a signal-to-interference ratio, SIR, target value;
generating the uplink data rate offset value in response to receiving the SIR target value; and
transmitting the uplink data rate offset value to the wireless terminal, after generating the uplink data rate offset value in response to receiving the SIR target value.

57. A node of a radio access network configured to provide communications with a wireless terminal, the node comprising:
transceiver circuitry configured to provide communications with the wireless terminal;
a network interface configured to provide communications with a Radio Network Controller; and
a processor coupled to the transceiver circuitry and the network interface, wherein the processor is configured to:
receive, through the network interface, from the Radio Network Controller an uplink data rate offset value used to adjust an uplink data rate of the wireless terminal, when the wireless terminal is in a soft handover; and
transmit the uplink data rate offset value through the transceiver circuitry to the wireless terminal when the wireless terminal is in the soft handover.

58. The node of claim 57,
wherein the node comprises a serving base station,
wherein the soft handover comprises a soft handover with respect to the serving base station and a non-serving base station, and
wherein the processor is configured to transmit the uplink data rate offset through the transceiver circuitry to the wireless terminal when the wireless terminal is in the soft handover with respect to the serving base station and the non-serving base station.

59. The node of claim 57, wherein the processor is configured to:
receive, through the transceiver circuitry, an uplink data block from the wireless terminal; and
transmit, through the network interface, to the Radio Network Controller a retransmission indication that indicates a quantity of retransmissions of the uplink data block by the wireless terminal.

60. The node of claim 57, wherein the processor is configured to:
compare the uplink data rate offset value with an initial uplink data rate offset value; and
transmit the uplink data rate offset value to the wireless terminal through the transceiver circuitry in response to determining that the uplink data rate offset value is different from the initial uplink data rate offset value.

61. The node of claim 57,
wherein the uplink data rate offset value comprises a rounded uplink data rate offset value, and
wherein the processor is configured to receive, through the network interface, the rounded uplink data rate offset value from the Radio Network Controller.

62. The node of claim 57, wherein the processor is configured to:
receive, through the network interface, from the Radio Network Controller a signal-to-interference ratio, SIR, target value;
generate the uplink data rate offset value in response to receiving the SIR target value; and
transmit the uplink data rate offset value to the wireless terminal through the transceiver circuitry, after generating the uplink data rate offset value in response to receiving the SIR target value.

63. A method in a wireless terminal, the method comprising:
transmitting an uplink data block to at least one of a non-serving base station and a serving base station when the wireless terminal is in a soft handover with respect to the serving base station and the non-serving base station; then
receiving, through the serving base station, an uplink data rate offset value generated by a Radio Network Controller used to adjust an uplink data rate of the wireless terminal, when the wireless terminal is in the soft handover.

64. The method of claim 63, wherein transmitting the uplink data block comprises transmitting, to at least one of the non-serving base station and the serving base station, the uplink data block and a retransmission indication comprising an indication of a quantity of retransmissions of the uplink data block by the wireless terminal to the non-serving base station and/or the serving base station.

65. The method of claim 63, wherein the wireless terminal comprises a wireless terminal scheduled to communicate using Enhanced Uplink, EUL.

66. A wireless terminal comprising:
a transceiver configured to provide communications with a non-serving base station and a serving base station; and
a processor coupled to the transceiver, wherein the processor is configured to:
transmit, through the transceiver, an uplink data block to at least one of the non-serving base station and the serving base station when the wireless terminal is in a soft handover with respect to the serving base station and the non-serving base station; then
receive, through the transceiver, from the serving base station, an uplink data rate offset value generated by a Radio Network Controller used to adjust an uplink data rate of the wireless terminal, when the wireless terminal is in the soft handover.

67. The wireless terminal of claim 66, wherein the processor is configured to transmit, to the non-serving base station and/or the serving base station, the uplink data block and a retransmission indication comprising an indication of a quantity of retransmissions of the uplink data block by the wireless terminal to the non-serving base station and/or the serving base station.

68. The wireless terminal of claim 66, wherein the wireless terminal comprises a wireless terminal scheduled to communicate using Enhanced Uplink, EUL.
